(19) United States
(12) Patent Application Publication
(10) Pub. No.: US 2017/0228128 A1
(43) Pub. Date: Aug. 10, 2017

(54) DEVICE COMPRISING TOUCHSCREEN AND CAMERA

(71) Applicant: TELEFONAKTIEBOLAGET LM ERICSSON, Stockholm (SE)

(72) Inventors: Matthew John LAWRENSON, Bussigny (CH); Julian Charles NOLAN, Pully (CH)

(73) Assignee: TELEFONAKTIEBOLAGET LM ERICSSON, Stockholm (SE)

(21) Appl. No.: 15/501,755

(22) PCT Filed: Aug. 4, 2014
(86) PCT No.: PCT/SE2014/050914

§ 371 Date: Feb. 3, 2017

(51) Int. Cl. G06F 3/0488; G06F 3/042

(52) U.S. Cl. CPC G06F 3/0488; G06F 3/042

(57) ABSTRACT

A device comprising a touchscreen and a camera for imaging a reflection of the touchscreen by a cornea of a user operating the device is provided. The device is configured for displaying a user-interface element on the touchscreen and detecting an interaction by a finger of a hand with the user-interface element. The device is further configured for, in response to detecting the interaction, acquiring an image of the reflection of the touchscreen from the camera, determining which finger of the hand is used for interacting with the user-interface element, and performing an action dependent on the finger used for the interaction. By also assigning a meaning to the finger which is being used for interacting with touchscreen-based devices, such that different actions are performed dependent on the finger used for the interaction, embodiments of the invention support simpler, faster, and more intuitive, user interaction.

### TECHNICAL FIELD

The invention relates to a device comprising a touchscreen and a camera, a method of a device comprising a touchscreen and a camera, a corresponding computer program, and a corresponding computer program product.

### BACKGROUND

The use of hand-held computing devices which incorporate touchscreens, such as smartphones, tablets, and the like, is intrinsically limited as compared to traditional computers, such as desktop-based computers and laptop computers. This is the case since the operation of touchscreens, which are electronic visual displays for displaying graphical information to the user while at the same time allowing the user to interact with the device, e.g., to enter information or to control the operation of the device, limits the way users can interact with the device.

A hand-held touchscreen-based device differs from traditional computers in a number of aspects. Firstly, hand-held devices are often operated with just one hand while being held with the other hand. Therefore, users lack the ability to press a modifier key, such as ‘Shift’, ‘Alt’, ‘Ctrl’, or the like, with the other hand while typing, as can be done on traditional computers in order to use shortcuts or alter the meaning of a key. Rather, one or more additional steps are required, such as first pressing a modifier key to switch between different layers of a virtual keyboard before entering a character.

In addition to that, touchscreen-based devices lack the cursor which traditional computers provide to facilitate navigating the user interface, typically operated by a mouse or a trackpad which allow users to perform actions which are assigned to separate buttons provided with the mouse or the trackpad. One example is the ability to open a context menu associated with an object displayed on the computer screen, and which typically is activated by ‘right-clicking’, i.e., pressing the right mouse button or trackpad button. Moreover, whereas for traditional computers, the cursor indicates the location on the computer screen which a mouse ‘click’ or trackpad ‘tap’ will act on, this is not the case for touchscreen-based devices. Rather, for current operating systems for touchscreen-based devices, such as Android, Symbian, and iOS, the location of an imaginary cursor and the location a touch should act on are one and the same. Whilst it is possible to use gestures or multi-finger touches, they are difficult to differentiate from a single touch during normal usage and are frequently perceived as being difficult to perform by users. Moreover, it is difficult to maintain location specificity, i.e., being able to act on a specific user-interface element or object which is displayed on the touchscreen.

The limited size of touchscreens and limitations in the users' ability to see items on the screen necessitates the use of layers in the operation of touchscreen-based devices, in particular in relation to virtual keyboards. This is the case, since the buttons of a virtual keyboard typically are too small to accommodate more than one character. For instance, to reach the ‘+’ symbol using one of Apple's iOS keyboards, the user must first press one virtual key to access a layer providing numbers and symbols, and then a second virtual key to access a secondary set of symbols provide by a further layer. Thus, the ‘+’ symbol is on the third keyboard layer.

For traditional computers, as a consequence of the ability to use both hands and sophistication of hardware devices such as keyboards, mice, and trackpads, concepts have developed which allow users to more easily interact with user interfaces of traditional computer. At least for the reasons discussed above, some of these concepts are difficult to translate to touchscreen-based devices, and the use of such devices is often slower and perceived as being less convenient as compared to traditional computers.

### SUMMARY

It is an object of the invention to provide an improved alternative to the above techniques and prior art.

More specifically, it is an object of the invention to provide an improved user interaction for touchscreen-based devices, in particular hand-held touchscreen-based devices.

These and other objects of the invention are achieved by means of different aspects of the invention, as defined by the independent claims. Embodiments of the invention are characterized by the dependent claims.

According to a first aspect of the invention, a device is provided. The device comprises a touchscreen and a camera. The camera is configured for imaging a reflection of the touchscreen by a cornea of a user operating the device. The device is configured for displaying a user-interface element on the touchscreen and detecting an interaction by a finger of a hand with the user-interface element. The device is further configured for, in response to detecting the interaction by the finger with the user-interface element, acquiring an image of the reflection of the touchscreen from the camera, determining which finger of the hand is used for interacting with the user-interface element, and performing an action dependent on the finger used for interacting with the user-interface element. The device is configured for determining which finger of the hand is used for interacting with the user-interface element by analyzing the image, e.g., by means of image processing.

According to a second aspect of the invention, a method of a device is provided. The device comprises a touchscreen and a camera. The camera is configured for imaging a reflection of the touchscreen by a cornea of a user operating the device. The method comprises displaying a user-interface element on the touchscreen and detecting an interaction by a finger of a hand with the user-interface element. The method further comprises, in response to detecting the interaction by the finger with the user-interface element, acquiring an image of the reflection of the touchscreen from the camera, determining which finger of the hand is used for interacting with the user-interface element, and performing an action dependent on the finger used for interacting with the user-interface element. The finger of the hand which is used for interacting with the user-interface element is determined by analyzing the image, e.g., by means of image processing.

According to a third aspect of the invention, a computer program is provided. The computer program comprises computer-executable instructions for causing the device to perform the method according to an embodiment of the second aspect of the invention, when the computer-executable instructions are executed on a processing unit comprised in the device.

According to a fourth aspect of the invention, a computer program product is provided. The computer program product comprises a computer-readable storage medium which has the computer program according to the third aspect of the invention embodied therein.

The invention makes use of an understanding that the interaction by users with devices incorporating touchscreens, by means of touching a user-interface element, i.e., a graphical object, being displayed on the touchscreen, can be improved by also assigning a meaning to the finger being used for the interaction. That is, an action which is performed by the device in response to the user interaction is dependent on the finger used for the interaction. In other words, different actions may be performed for the different fingers of the hand. Embodiments of the invention are advantageous in that they support simpler, faster, and more intuitive, interaction by users with touchscreen-based devices.

In the present context, touchscreen-based devices are, e.g., hand-held devices such as smartphones, mobile terminals, or tablet computers such as Apple's iPad or Samsung's Galaxy Tab, but include also other types of devices which typically are operated by just one hand, e.g., built-in displays in cars or vending machines. A touchscreen is an electronic visual display which provides graphical information to the user and allows the user to input information to the device, or to control the device, by touches or gestures made by touching the screen. That is, the touchscreen constitutes a user interface though which the user can interact with the device. Touching a graphical object displayed on the screen, i.e., a user-interface element, is the equivalent to clicking or tapping, using a mouse or trackpad, respectively, on a graphical object displayed on a screen of a traditional computer. In other words, a user-interface element is a graphical object being displayed on the touchscreen and which the user can interact with. Examples of user-interface elements are a virtual button or key, a link, such as a Uniform Resource Locator (URL) link, a picture, a piece of text, a text field for entering text, or the like. Typically, the user interface displayed on the touchscreen is composed of several user-interface elements.

The finger which is used for interacting with the user-interface element, i.e., touching the touchscreen, is determined by means of corneal imaging. Corneal imaging is a technique which utilizes a camera for imaging a person's cornea for gathering information about what is in front of the person and also, owing to the spherical nature of the human eyeball, for gathering information about objects in a field-of-view wider than the person's viewing field-of-view. Such objects may potentially be outside the camera's field-of-view and even be located behind the camera. The technique is made possible due to the highly reflective nature of the human cornea, and also the availability of high-definition cameras in user devices such as smartphones and tablet computers. In the present context, the finger which is used for interacting with the user-interface element displayed in the touchscreen is understood to be one of the fingers of the human hand, i.e., one of index finger, middle finger, ring finger, pinky, and thumb, rather than a specific finger of a specific person. It will be appreciated that the finger interacting with the device is not necessarily a finger of the user or owner of the device or the person holding the device, but may belong to a different person. In other words, the finger touching the touchscreen may belong to someone sitting next to the user holding the device.

The camera on which embodiments of the invention are based has a field of view which is directed into substantially the same direction as the viewing direction of the touchscreen. Preferably, the camera and the touchscreen are provided on the same face of the device. Cameras in such arrangements are commonly referred to as front-facing.

According to an embodiment of the invention, the device is configured for detecting an interaction by the finger with the user-interface element by detecting that the finger touches, or is about to touch, a surface area of the touchscreen associated with the user-interface element. The surface area is typically of substantially the same size and shape as the user-interface element, such as the area of a virtual button or a rectangular area around a piece of text, e.g., URL in a displayed web page. Embodiments of the invention which are based on detecting that the finger is about to touch the touchscreen, i.e., predicting the touch, can be achieved by utilizing a capacitive touchscreen. Alternatively, corneal imaging may be used for detecting that the finger is about to touch the touchscreen. Predicting the touch is advantageous in that an action may be performed before the finger actually touches the screen. To this end, the displayed user-interface element may be modified in response to detecting that the finger is about to touch the surface area of the touch screen associated with the user-interface element, wherein the user-interface element is modified dependent on the finger which is about to touch the user-interface element. Alternatively, a further user-interface element may be displayed in response to detecting that the finger is about to touch the screen.

According to an embodiment of the invention, the user-interface element is a virtual. Optionally, the touchscreen may be configured for displaying a user-interface element on the touchscreen by displaying a virtual keyboard comprising a plurality of virtual buttons. In this case, the finger which interacts with the user-interface element is the finger which touches one of the virtual buttons. Optionally, the device may be configured for performing an action dependent on a finger used for interacting with the virtual button by entering a character, i.e., a letter, a number, or a special character, associated with the virtual button which with the finger interacts. Further optionally, a plurality of characters may be associated with each virtual button, wherein each character is associated with a respective finger of the hand, and the device is configured for performing an action dependent on a finger used for interacting with the virtual button by entering the character associated with the virtual button and the finger used for interacting with the virtual button. As an example, one may consider a virtual keyboard comprising one or more modifier keys which are used for switching between different layers of the virtual keyboard, e.g., a first layer comprising lower case letters, a second layer comprising upper case letters, and a third layer comprising numbers and special characters. That is, the different fingers of the hand are associated with different modifier keys, or different layers of the keyboard, respectively. For instance, a lower case letter which is associated with a virtual button may be associated with a first finger of the hand, and/or an upper case letter which is associated with the virtual button may be associated with a second finger of the hand, and/or a number which is associated with the virtual button may be associated with a third finger of the hand. Thereby, the user can enter lower case letters with, e.g., his/her index finger, upper case letters with his/her middle finger, and numbers or non-alphanumeric characters, with his/her ring finger. This is advantageous in that the user is not required to use modifier keys but can simply alternate between fingers when typing. Moreover, if the touchscreen is configured for detecting an interaction by the finger with the user-interface element by detecting that the finger is about to touch a surface area of the touchscreen associated with the user-interface element, i.e., if touch prediction is used, the virtual keyboard may switch between different layers depending on which finger is about to touch the touchscreen. Thereby, only one character per button is displayed at a time, the displayed character being modified dependent on the finger which is about to touch the screen.

According to an embodiment of the invention, the device is configured for performing an action dependent on a finger used for interacting with the user-interface element by performing a left-click type of action if a first finger of the hand is used for interacting with the user-interface element. Alternatively, or additionally, the device may be configured for performing an action dependent on a finger used for interacting with the user-interface element by performing a right-click type of action if a second finger, which is different from the first finger, of the hand is used for interacting with the user-interface element. The terms ‘left-click’ and ‘right-click’ refer, throughout this disclosure, to the well-known mouse- and trackpad-based concepts used with traditional computers. Whereas left-clicking typically is equivalent to pressing ‘Enter’ on a computer, i.e., performing a default action like starting a program or opening a document which the user-interface element represents, an alternative action is regularly associated with right-clicking. Optionally, the right-click type of action may be opening a contextual menu which is associated with the user-interface element. This is advantageous in that actions may be performed in an easier way as compared to known touchscreen devices, in particular involving fewer interaction steps. Other actions may additionally be assigned to other fingers.

Even though advantages of the invention have in some cases been described with reference to embodiments of the first aspect of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIGS. 1a and 1b illustrate interaction by a user with a touchscreen-based device, in accordance with an embodiment of the invention.

FIGS. 2a and 2b show a touchscreen-based device, in accordance with an embodiment of the invention.

FIGS. 3a and 3b show a touchscreen-based device, in accordance with another embodiment of the invention.

FIGS. 4a and 4b show a touchscreen-based device, in accordance with a further embodiment of the invention.

FIG. 5 shows a processing unit of a touchscreen-based device, in accordance with an embodiment of the invention.

FIG. 6 shows a method of a touchscreen-based device, in accordance with an embodiment of the invention.

FIG. 7 shows a processing unit of a touchscreen-based device, in accordance with another embodiment of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

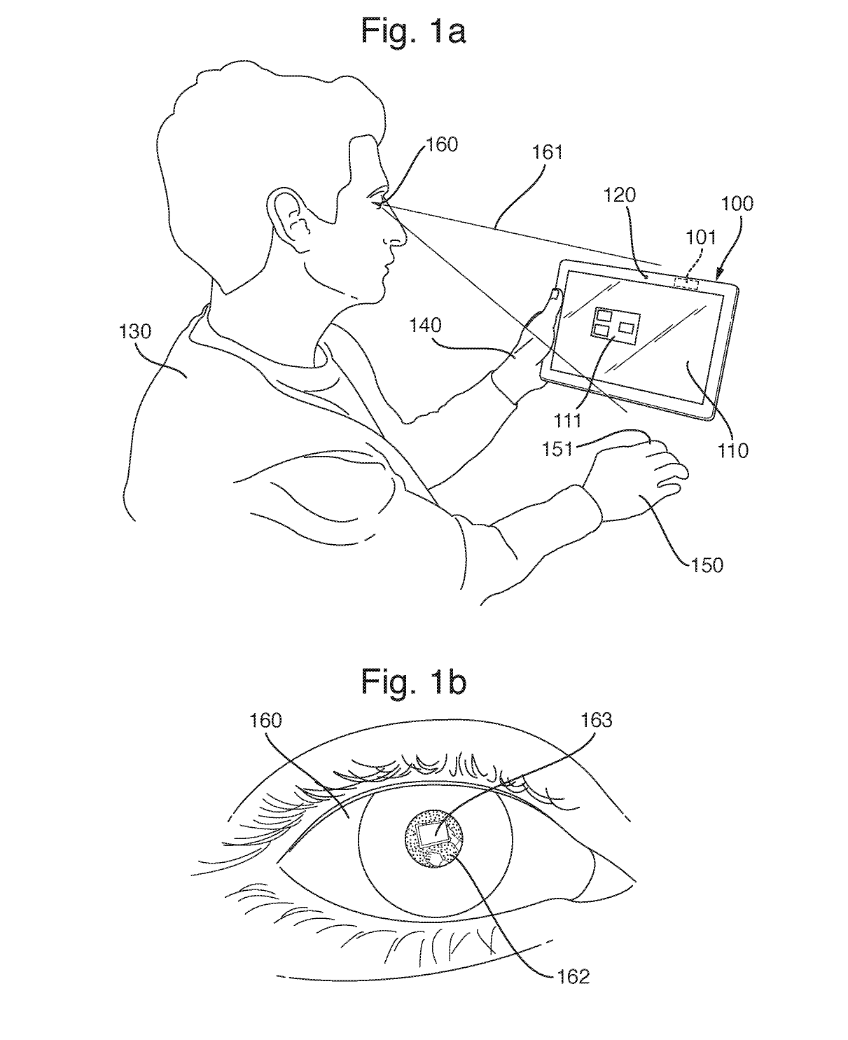

In FIG. 1a, a hand-held touchscreen device is illustrated, exemplified as a tablet 100, in accordance with an embodiment of the invention. Device 100 comprises a touchscreen 110 and a camera 120 and is illustrated as being held by a first (left) hand 140 of a user 130.

Touchscreen 110 is configured for displaying a user-interface element 111, i.e., a graphical object such as a (virtual) button, text, a field for entering text, a picture, an icon, a URL, or the like. Device 100 is configured for, e.g., by virtue of touchscreen 100, detecting an interaction by a finger 151 of a hand 150, in FIG. 1a second (right) hand of user 130, with user-interface element 111. The interaction is illustrated as finger 151 touching user-interface element 111. To this end, touchscreen 110 constitutes a user interface through which user 130, or any other person, can interact with device 100, i.e., enter information or control device 100. Typically, the user interface comprises multiple user-interface elements, i.e., several objects are displayed on touchscreen 110, and the appearance of the user interface, i.e., the number and type of user-interface elements, is controlled by an operating system or an application being executed on a processing unit 101 comprised in device 100. Note that for touchscreen-based devices such as device 100, touching a user-interface element corresponds to clicking or tapping on a user-interface element known from traditional mouse- or trackpad-based computers. The finger may be any one of an index, middle finger, ring finger, pinky, and thumb, of user 130 or any other person, e.g., someone sitting next to user 130.

Camera 120 has a field of view which is directed into the same direction as the viewing direction of touchscreen 110. Camera 120 and touchscreen 110 are typically provided on the same face of device 100, i.e., camera 120 is a front-facing camera 120. Optionally, device 100 may comprise multiple front-facing cameras and also a rear-facing camera. Camera 120 is configured for imaging a reflection 163 of touchscreen 110 by a cornea 162 of an eye 160 of user 130 operating device 100, as is illustrated in FIG. 1b. Embodiments of the invention utilize camera 120 which device 100 is provided with for determining which finger of a hand interacts with touchscreen 110, as is described further below. The technique of corneal imaging is made possible by the spherical nature of the human eyeball allowing gathering information about objects in a field of view 162 wider than the person's viewing field-of-view.

It will be appreciated that reflection 163 may optionally arise from a contact lens placed on the surface of eye 160, or even from eyeglasses or spectacles worn in front of eye 160 (not shown in FIGS. 1a and 1b).

Even though device 100 is in FIG. 1a illustrated as being a tablet computer, or simply tablet, it may be any type of touchscreen-based device, in particular a hand-held device, such as a smartphone, a mobile terminal, a UE, or the like, but may also be a built-in display of type which is frequently found in cars or vending machines.

Device 100 is configured for, in response to detecting the interaction by finger 151 with user-interface element 111, acquiring an image of reflection 163 of touchscreen 110 from camera 120. The interaction by finger 151 with touchscreen 110, i.e., finger 151 touching a surface of touchscreen 110, is detected by touchscreen 110 together with a location of the interaction. Different types of touchscreens are known in the art, e.g., resistive and capacitive touchscreens. The location of the interaction, i.e., the location where finger 151 touches touchscreen 110, is used to determine which of one or more displayed user-interface elements finger 151 interacts with. This may, e.g., be achieved by associating a surface area of touchscreen 110 with each displayed user-interface element, such as the area defined by a border of a virtual button or picture, or a rectangular area coinciding with a text field or URL link. If the location of the detected touch is within a surface area associated with a user-interface element, it is inferred that the associated user-interface element is touched.

Acquiring an image of reflection 163 of touchscreen 110 from camera 120 may, e.g., be accomplished by requesting camera 120 to capture an image, i.e., a still image. Alternatively, camera 120 may continuously capture images, i.e., video footage, while finger 151 is touching touchscreen 110, e.g., because user 130 is involved in a video call. In this case, device 100 may be configured for selecting from a sequence of images received from camera 120 an image which has captured the interaction. Device 100 is further configured for determining which finger 151 of hand 150 is used for interacting with user-interface element 111. This is achieved by analyzing the acquired image, i.e., by image processing, as is known in the art. Typically, a number of biometric points related to the geometry of the human hand are used to perform measurements and identify one or more fingers and optionally other parts of hand 150. Device 100 is further configured for, subsequent to determining which finger 151 is used for touching user-interface element 111, performing an action which is dependent on finger 151 used for interacting with user-interface element 111. Different actions are performed for the different fingers of hand 150, as is described further below.

In the following, the determining which finger 151 of hand 150 is used for interacting with user-interface element 111 is described in more detail. First, an image is acquired from camera 120, either by requesting camera 120 to capture an image or by selecting an image from a sequence of images received from camera 120. Then, by means of image processing, an eye 160 of user 130 is detected in the acquired image, and cornea 162 is identified. Further, reflection 163 of touchscreen 110 is detected, e.g., based on the shape and the visual appearance of touchscreen 110, i.e., the number and arrangement of the displayed user-interface elements, which are known to device 100. Then, the acquired image, or at least a part of the acquired image showing at least finger 151 touching user-interface element 111, is analyzed in order to determine which finger 151 of hand 150 is used for the interaction.

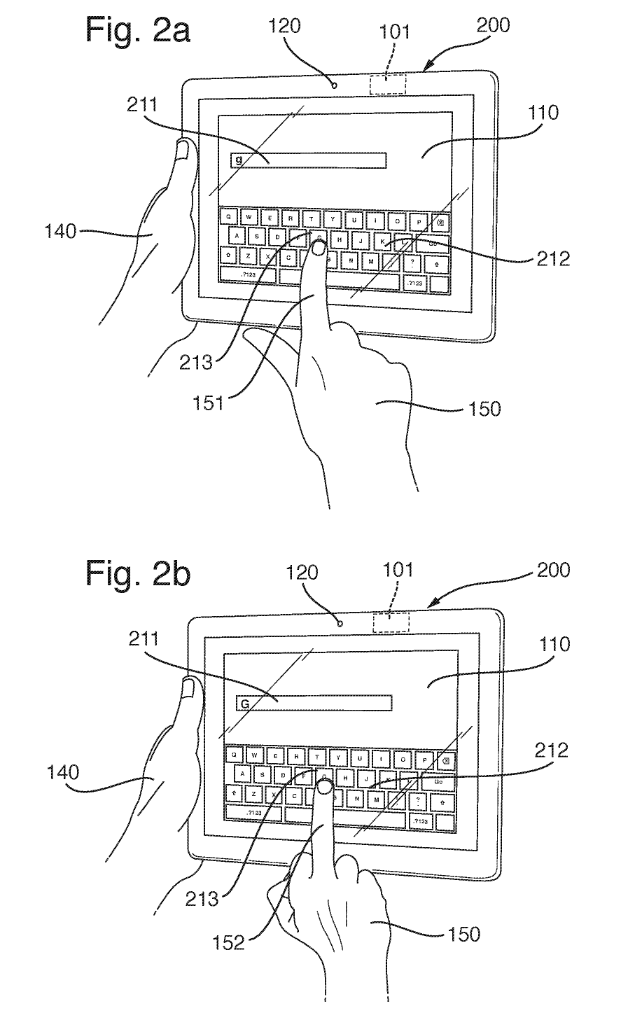

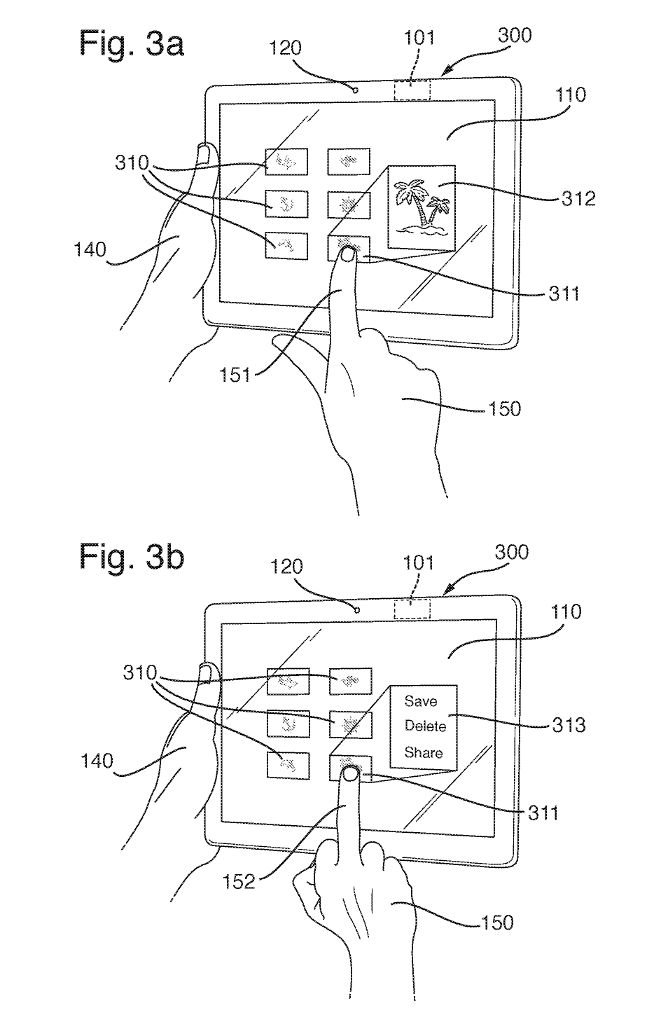

Subsequent to determining which finger 151 of hand 150 is user for interacting with a user-interface element 111 displayed on touchscreen 110, an action dependent on the finger used for interacting with the user-interface element is performed, as is described hereinafter in more detail with reference to FIGS. 2 and 3. As an example, device 100 may be configured for performing a ‘Copy’ action if a first finger, such as the index finger, of hand 150 is used for interacting with user-interface element 111, and/or a ‘Paste’ action if a second finger, such as the middle finger, of hand 150 is used for interacting with user-interface element 111. Alternatively, rather than ‘Copy’ or ‘Paste’, any other action provided by an operating system of device 100 or an application being executed by processing unit 101 may be associated with one or more fingers, depending on the type of user-interface element 111. Examples for such actions include ‘Cut’, ‘New’, ‘Open’, ‘Save’, ‘Save as’, ‘Close’, ‘Edit’, and so forth. As yet a further alternative, scroll actions which are known from mice and trackpads may be associated with one or more fingers, at least for certain types of user-interface elements. For instance, if the size of a user-interface element is such that it cannot be displayed in its entirety on touchscreen 110, e.g., a text page, a web page, or a large picture, it may be moved across touchscreen 110 while touching it with a finger, such that hidden parts of the user-interface element become visible. In such case, different scroll speeds may be associated with the different fingers of the hand. For instance, defining a scroll ratio as the distance the user-interface element, or a part of it, such as a web page within a web browser, is moved as compared to the distance the touching finger is moved over touchscreen 110, the index finger may be associated with a scroll speed having a ratio of 1:1, whereas the middle finger may be associated with a scroll speed having a ratio of 3:1. In that case, if user 130 moves his/her index finger while touching touchscreen 110 by a certain distance, the touched user-interface element is moved by the same distance. If, on the other hand, user 130 moves his/her middle finger while touching touchscreen 110 by that distance, the touched user-interface element is moved by three times the distance, owing to the scroll ratio of 3:1.

It will be appreciated that the performed action may also be dependent on the user-interface element or a type of the user-interface element, as is known from traditional computers. That is, different actions, e.g., different default applications, may be associated with virtual buttons, pictures, text fields, icons, and so forth.

In FIGS. 2a and 2b, an embodiment 200 of the hand-held touchscreen-based device is illustrated. Device 200 is similar to device 100 shown in FIG. 1a and comprises a touchscreen 110, a camera 120, and a processing unit 101. Device 200 is illustrated as displaying two user-interface elements, a text field 211 and a virtual keyboard 212 comprising a plurality of virtual buttons. For instance, a user of device 200 may use an editor of an email application for creating an email, or entering a URL in the address field of a web browser. As is illustrated in FIG. 2a, upon touching one of the virtual buttons, e.g., button 213, with index finger 151, the user may enter a character which is associated with, and displayed on, virtual button 213 into text field 211, in this case the lower case letter ‘g’. If, on the other hand, middle finger 152 is used for touching virtual button 213, as is illustrated in FIG. 2b, the upper case letter which corresponds to the letter displayed on virtual button 213, in this case ‘G’, is entered in text field 211. Note that embodiments of the invention are not limited to the particular choice of fingers and/or characters. In general, a plurality of characters may be associated with each virtual button, wherein each character is associated with a respective finger of the hand, and device 200 may be configured for entering the character which is associated with the virtual button which the user touches and the finger used for touching the virtual button. For instance, a lower case letter, such as ‘g’, may be associated with a first finger of the hand, and/or an upper case letter may be associated with a second finger of the hand. Preferably the upper case letter corresponds to the lower case letter which is associated with the first finger, in this case ‘G’. Optionally, a number and/or non-alphanumeric characters, commonly referred to as special characters, may be associated with a third finger of the hand.

The embodiment described with reference to FIGS. 2a and 2b corresponds to a virtual keyboard comprising one or more modifier keys which are used for switching between different layers of the keyboard, e.g., a first layer comprising lower case letters, a second layer comprising upper case letters, and a third layer comprising numbers and special characters. As an alternative to associating the different layers of a virtual keyboard with different fingers, as is described hereinbefore, one or more modifier keys may be associated with one or more fingers. For instance, using the index finger for entering characters using a virtual keyboard may correspond to using no modifier key, i.e., the characters which are displayed on the virtual buttons of the virtual keyboard are entered, whereas using the middle finger may correspond to pressing ‘Shift’ simultaneously, i.e., the corresponding upper case letters are entered. Further, the ring finger may correspond to pressing first ‘Shift’ and then a further modifier key, thereby accessing a keyboard layer with numbers and special characters.

In FIGS. 3a and 3b, another embodiment 300 of the hand-held touchscreen-based device is illustrated. Device 300 is similar to device 100 shown in FIG. 1a and comprises a touchscreen 110, a camera 120, and a processing unit 101. In FIG. 3a device 300 is illustrated as displaying six pictures 310 of thumbnail size, each picture being a user-interface element. For instance, a user of device 300 may use an application for viewing a collection of pictures, and which allows the user to perform further actions on the displayed pictures. For instance, as is illustrated in FIG. 3a, upon touching one of the pictures 310, e.g., picture 311, with index finger 151, a left-click type of action is performed on the touched picture 311. Typically, on a conventional computer a default action is associated with left-clicking, i.e., the action which is performed when a user-interface element is selected and ‘Enter’ is hit. Frequently, the default action may be opening a default application associated with the user-interface element. With reference to FIG. 3a, device 300 may be configured for opening the touched picture 311 in a viewer application 312, thereby enlarging the picture 311. If, on the other hand, middle finger 152 is used for touching picture 311, as is illustrated in FIG. 3b, a different action is performed for the touched picture 311, e.g., sharing the picture, deleting the picture, or the like. Optionally, device 300 may be configured for displaying a contextual menu 313 which is associated with picture 311, or pictures (as a type of user-interface element) in general. Contextual menu 313 provides a number of different actions, in FIG. 3b illustrated as ‘Save’, ‘Delete’, and ‘Share’, from which the user can select an action to be performed by touching the corresponding menu item. Note that in this case the user has to touch twice, first to open contextual menu 133, and then to select an action from contextual menu 133.

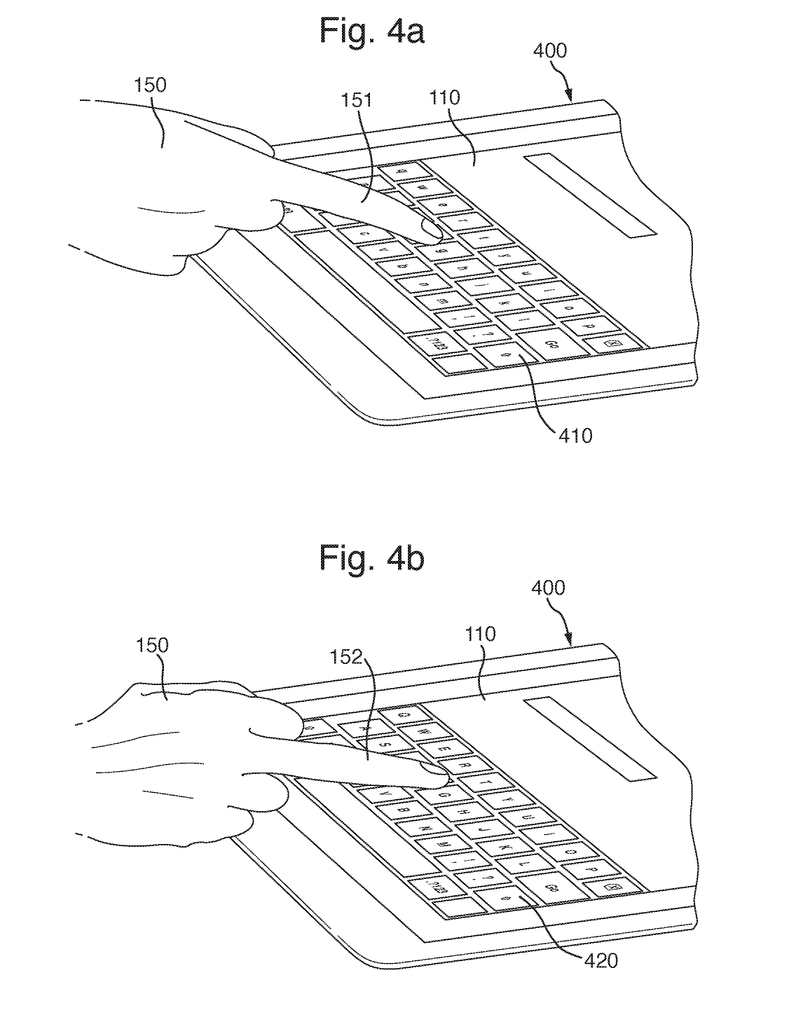

With reference to FIGS. 4a and 4b, a further embodiment 400 of the hand-held touchscreen-based device is illustrated. Device 400 is similar to device 100 shown in FIG. 1a and comprises a touchscreen 110, a camera (similar to camera 120, not shown in FIG. 4), and a processing unit (similar to processing unit 101, not shown in FIG. 4). Device 400 is illustrated as displaying a virtual keyboard 410 and 420, comprising a plurality of virtual buttons, or keys, similar to device 200 described with reference to FIGS. 2a and 2b. In contrast to device 200, device 400 is configured for detecting that a finger is about to touch one of the buttons. That is, device 400 is configured for predicting the touch rather than, or in addition to, detecting the touch. Predicting the touch may be accomplished using a capacitive touchscreen 110, as is known in the art. Alternatively, if the camera is arranged for capturing a sequence of images, the touch may be predicted by analyzing, i.e., image processing, the sequence of images received from the camera. Optionally, device 400 may be further configured for, in response to detecting that a finger is about to touch one of the user-interface elements, modifying the user-interface element. For instance, virtual keyboard 410 and 420 may switch between different layers depending on which finger, index finger 151 or middle finger 152, is about to touch touchscreen 110. This is illustrated in FIGS. 4a and 4b, respectively, which show that a first keyboard layer 410 of lower case letters is displayed if index finger 151 is about to touch touchscreen 110, whereas a second keyboard layer 420 of upper case letters is displayed if middle finger 152 is about to touch touchscreen 110. This is advantageous in that only one character at a time is displayed on each virtual button, but the displayed character is modified in accordance with the finger which is about to touch touchscreen. As an alternative, embodiments of the invention displaying a collection of user-interface elements, such as virtual keyboard 410 and 420, may also be configured for modifying only a single user-interface element, or a portion of user-interface elements, of a collection of user-interface elements, e.g., the virtual button which a user of device 400 is about to touch.

As a further example with reference to FIGS. 4a and 4b, a collection of pictures may be displayed, similar to what is illustrated in FIG. 3. In such case, one finger of the hand, e.g., middle finger 152, may be associated with the action to ‘Share this picture’. Accordingly, device 400 may be configured for displaying, if it is detected that middle finger 152 is about to touch one of the displayed pictures (such as picture 311 in FIG. 3), a contextual menu (similar to contextual menu 313 in FIG. 3) providing the user of device 400 with a list of alternatives for sharing the picture, e.g., using Mail, MMS, WhatsApp, Facebook, or the like. From the contextual menu, the user may then select an action, i.e., an alternative for sharing the picture, by actually touching touchscreen 110. In comparison to what is described with reference to FIG. 3, this is advantageous in that, rather than touching touchscreen 110 twice, first for opening contextual menu 313 and then for selecting one of the alternatives provided by contextual menu 313, only a single touch is required. That is, the contextual menu is displayed in response to detecting that middle finger 152 is about to touch touchscreen 110, and the selection is made when finger 152 eventually touches touchscreen 110.

It will be appreciated that embodiments of the invention may comprise different means for implementing the features described hereinbefore, and these features may in some cases be implemented according to a number of alternatives. For instance, displaying a user-interface element and detecting an interaction by a finger of a hand with the user-interface element may, e.g., be performed by processing unit 101, presumably executing an operating system of devices 100, 200, 300, or 400, in cooperation with touchscreen 110. Further, acquiring an image of the reflection of touchscreen 110 from camera 120 may, e.g., be performed by processing unit 101 in cooperation with camera 120. Finally, performing an action dependent on the finger used for interacting with the user-interface element is preferably be performed by processing unit 101.

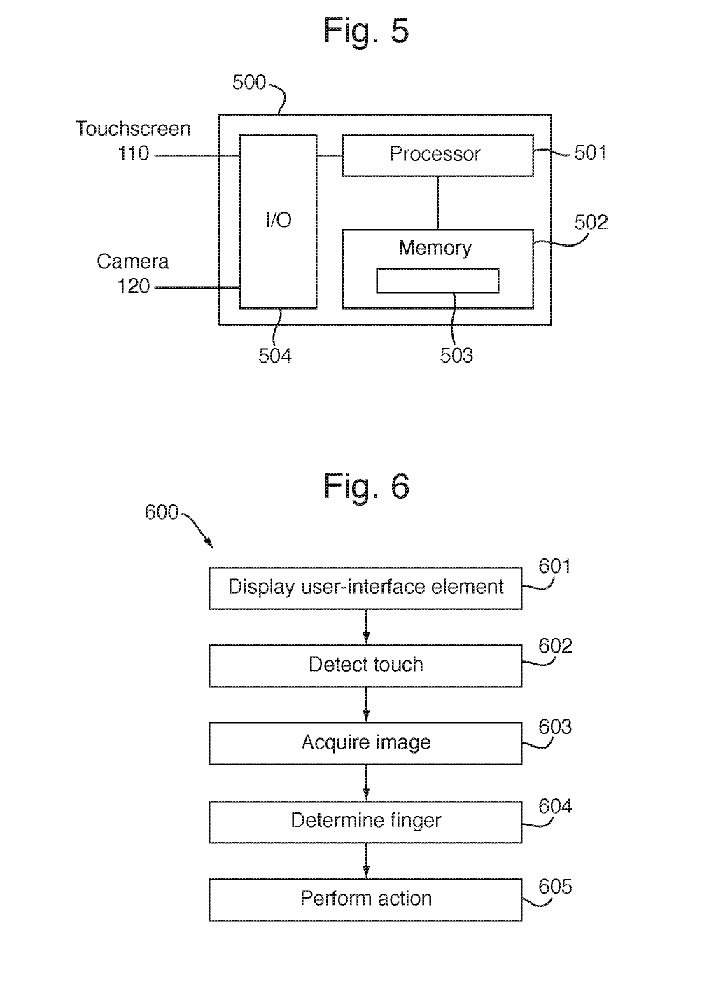

In FIG. 5, an embodiment 500 of processing unit 101 is shown. Processing unit 500 comprises a processor 501, e.g., a general purpose processor or a Digital Signal Processor (DPS), a memory 502 containing instructions, i.e., a computer program 503, and an interface 504 (“I/O” in FIG. 5) for receiving information from, and controlling, touchscreen 110 and camera 120, respectively. Computer program 503 is executable by processor 501, whereby devices 100, 200, 300, and 400, are operative to perform in accordance with embodiments of the invention, as described hereinbefore with reference to FIGS. 1 to 4.

In FIG. 6, a flowchart illustrating an embodiment 600 of the method of a device is illustrated, the device comprising a touchscreen and a camera configured for imaging a reflection of the touchscreen by a cornea of a user operating the device. Method 600 comprises displaying 601 a user-interface element on the touchscreen, detecting 602 an interaction by a finger of a hand with the user-interface element, and in response to detecting the interaction by the finger with the user-interface element, acquiring 603 an image of the reflection of the touchscreen from the camera, determining 604, by analyzing the image, which finger of the hand is used for interacting with the user-interface element, and performing 605 an action dependent on the finger used for interacting with the user-interface element. It will be appreciated that method 600 may comprise additional, or modified, steps in accordance with what is described hereinbefore. An embodiment of method 600 may be implemented as software, such as computer program 503, to be executed by a processor comprised in the device (such as processor 501 described with reference to FIG. 5), whereby the device is operative to perform in accordance with embodiments of the invention, as described hereinbefore with reference to FIGS. 1 to 4.

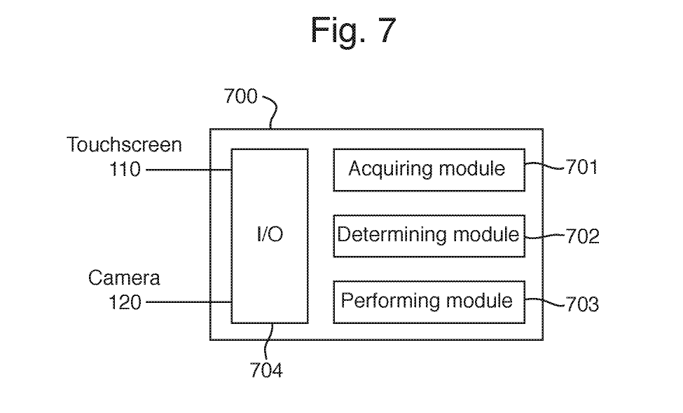

In FIG. 7, an alternative embodiment 700 of processing unit 101 is shown. Processing unit 700 comprises an acquiring module 701 configured for acquiring, in response to touchscreen 110 detecting an interaction by a finger of a hand with the user-interface element, an image of the reflection of the touchscreen from camera 120, a determining module 702 for determining, by analyzing the image, which finger of the hand is used for interacting with the user-interface element, a performing module 703 for performing an action dependent on the finger used for interacting with the user-interface element, and an interface 704 (“I/O” in FIG. 7) for receiving information from, and controlling, touchscreen 110 and camera 120, respectively. It will be appreciated that processing unit 700 may comprise further, or modified, modules, e.g., for displaying a user-interface element on touchscreen 110 and detecting an interaction by a finger of a hand with the displayed user-interface element. It will be appreciated that modules 701-704 may be implemented by any kind of electronic circuitry, e.g., any one or a combination of analogue electronic circuitry, digital electronic circuitry, and processing means executing a suitable computer program.

The person skilled in the art realizes that the invention by no means is limited to the embodiments described above. On the contrary, many modifications and variations are possible within the scope of the appended claims. In particular, embodiments of the invention are not limited to the specific choices of user-interface elements, fingers, and actions, used for exemplifying embodiments of the invention. Rather, one may easily envisage embodiments of the invention involving any kind of user-interface element and corresponding actions, whereby different fingers of the hand are associated with at least some of the actions for the purpose of improving user interaction with touchscreen-based devices.

1. A device comprising:
a touchscreen; and
a camera configured for imaging a reflection of the touchscreen by a cornea of a user operating the device, the device being configured for:
displaying a user-interface element on the touchscreen;
detecting an interaction by a finger of a hand with the user-interface element; and
in response to detecting the interaction by the finger with the user-interface element:
acquiring an image of the reflection of the touchscreen from the camera;
determining, by analyzing the image, which finger of the hand is used for interacting with the user-interface element; and
performing an action dependent on the finger used for interacting with the user-interface element.

2. The device according to claim 1, being configured for detecting an interaction by the finger with the user-interface element by detecting that the finger touches or is about to touch a surface area of the touchscreen associated with the user-interface element.

3. The device according to claim 2, being configured for, in response to detecting that the finger is about to touch the surface area of the touch screen associated with the user-interface element, modifying the displayed user-interface element or displaying a further user-interface element.

4. The device according to claim 1, being configured for performing an action dependent on a finger used for interacting with the user-interface element by:
performing a copy action if a first finger of the hand is used for interacting with the user-interface element; and/or
performing a paste action if a second finger of the hand is used for interacting with the user-interface element.

5. The device according to claim 1, wherein the user-interface element is a virtual button and the device is further configured for:
displaying a user-interface element on the touchscreen by displaying a virtual keyboard comprising a plurality of virtual buttons; and
performing an action dependent on a finger used for interacting with the virtual button by entering a character associated with the virtual button,
wherein a plurality of characters is associated with each virtual button, each character being associated with a respective finger of the hand, the device being configured for performing an action dependent on a finger used for interacting with the virtual button by entering the character associated with the virtual button and the finger used for interacting with the virtual button.

6.-8. (canceled)

9. The device according to claim 5, wherein:
a lower case letter is associated with a first finger of the hand; and/or
an upper case letter is associated with a second finger of the hand; and/or
a number is associated with a third finger of the hand.

10. The device according to claim 1, being configured for performing an action dependent on a finger used for interacting with the user-interface element by:
performing a left-click type of action if a first finger of the hand is used for interacting with the user-interface element; and/or
performing a right-click type of action if a second finger of the hand is used for interacting with the user-interface element.

11. The device according to claim 10, wherein the right-click type of action is opening a contextual menu associated with the user-interface element.

12. (canceled)

13. The device according to claim 1, wherein the device is any one of a display, a mobile terminal, or a tablet.

14. A method of a device comprising:
a touchscreen; and
a camera configured for imaging a reflection of the touchscreen by a cornea of a user operating the device, the method comprising:
displaying a user-interface element on the touchscreen;
detecting an interaction by a finger of a hand with the user-interface element; and
in response to detecting the interaction by the finger with the user-interface element:
acquiring an image of the reflection of the touchscreen from the camera;
determining, by analyzing the image, which finger of the hand is used for interacting with the user-interface element; and
performing an action dependent on the finger used for interacting with the user-interface element.

15. The method according to claim 14, wherein the detecting an interaction by a finger with the user-interface element comprises detecting that the finger touches or is about to touch a surface area of the touchscreen associated with the user-interface element.

16. The method according to claim 15, wherein the performing an action dependent on the finger used for interacting with the user-interface element comprises, in response to detecting that the finger is about to touch the surface area of the touch screen associated with the user-interface element, modifying the displayed user-interface element or displaying a further user-interface element.

17. The method according to claim 14, wherein the performing an action dependent on the finger used for interacting with the user-interface element comprises:
performing a copy action if a first finger of the hand is used for interacting with the user-interface element; and/or
performing a paste action if a second finger of the hand is used for interacting with the user-interface element.

18. The method according to claim 14, wherein the user-interface element is a virtual button;
wherein the displaying a virtual button on the touchscreen comprises displaying a virtual keyboard comprising a plurality of virtual buttons;
wherein the performing an action dependent on a finger used for interacting with the virtual button comprises entering a character associated with the virtual button; and
wherein a plurality of characters is associated with each virtual button, each character being associated with a respective finger of the hand, and the performing an action dependent on a finger used for interacting with the virtual button comprises entering the character associated with the virtual button and the finger used for interacting with the virtual button.

19.-21. (canceled)

22. The method according to claim 14, wherein:
a lower case letter is associated with a first finger of the hand; and/or
an upper case letter is associated with a second finger of the hand; and/or
a number is associated with a third finger of the hand.

23. The method according to claim 14, wherein the performing an action dependent on the finger used for interacting with the user-interface element comprises:
performing a left-click type of action if a first finger of the hand is used for interacting with the user-interface element; and/or
performing a right-click type of action if a second finger of the hand is used for interacting with the user-interface element.

24. The method according to claim 23, wherein the right-click type of action is opening a contextual menu associated with the user-interface element.

25. The method according to claim 14, wherein the camera is a front-facing camera.

26. The method according to claim 14, wherein the device is any one of a display, a mobile terminal, or a tablet.

27. A computer program comprising computer-executable instructions for causing the device to perform the method according to claim 14, when the computer-executable instructions are executed on a processing unit comprised in the device.

28. A computer program product comprising a non-transitory computer-readable storage medium, the computer-readable storage medium having a computer program comprising computer-executable instructions for causing the device to perform the method according to claim 14, when the computer-executable instructions are executed on a processing unit comprised in the device.
